(19) United States
(12) Patent Application Publication
(10) Pub. No.: US 2020/0056054 A1
(43) Pub. Date: Feb. 20, 2020

(54) MULTI-SCALE BLOCK COPOLYMER COATING THAT INDUCES HYDROPHOBIC PROPERTIES

(71) Applicant: Massachusetts Institute of Technology, Cambridge, MA (US)

(72) Inventors: Mukarram Ahmad Tahir, Cambridge, MA (US); Karim Raafat Gadelrab, Boston, MA (US); Yi Ding, Cambridge, MA (US); Li-Chen Cheng, Boston, MA (US); Caroline A, Ross, Arlington, MA (US); Alfredo Alexander-Katz, Cambridge, MA (US)

(21) Appl. No.: 16/349,819

(22) PCT Filed: Nov. 29, 2017
(86) PCT No.: PCT/US2017/063592

§ 371 Date: May 14, 2019

Related U.S. Application Data
(60) Provisional application No. 62/429,246, filed on Dec. 2, 2016.

(51) Int. Cl. C09D 5/00; C09D 183/10; C03C 17/34; C03C 17/42

(52) U.S. Cl. CPC C09D 5/002; C09D 183/10; C03C 2218/33; C03C 17/42; C03C 2217/76; C03C 17/3405

(57) ABSTRACT

Disclosed are methods of coating a surface of a substrate with a hydrophobic layer based on iterative steps of spin-coating, annealing, and etching of block copolymer thin films into multi-layer nano-meshes. Also disclosed are articles comprising a surface with a polymer coating, and methods of using the same as a self-cleaning surface.

### RELATED APPLICATION

This application claims the benefit of priority to U.S. Provisional Patent Application Ser. No. 62/429,246, filed Dec. 2, 2016, which is herein incorporated by reference in its entirety.

### BACKGROUND

Functionalizing surfaces with super-hydrophobic coating is a promising route for developing self-cleaning surfaces. Current manufacturing approaches, however, rely on expensive and inefficient methods like lithography and chemical vapor deposition. Further, materials typically utilized today are particulate or non-permanent polymer-based films, so the hydrophobic properties are generally not durable. Thus, alternative approaches to self-cleaning surfaces are needed.

### SUMMARY

Disclosed are scalable and low-cost methods for functionalizing a surface with a hydrophobic monolayer that is highly durable and does not modify the optical properties of the underlying material. The approach is a simple manufacturing process that involves iterative steps of spin-coating, annealing, and etching of block copolymer thin films into multi-layer nano-meshes. The result is a cost-effective and robust method of imparting super-hydrophobicity to materials in optically sensitive settings, like photovoltaics, tactile surfaces, optical lenses, and vehicular windshields.

In one aspect, the disclosure relates to a method of coating a surface of a substrate, comprising the steps of:

(a) providing a substrate;

(b) coating the substrate with a first block copolymer;

(c) annealing the first block copolymer on the surface;

(d) etching the first block copolymer by a first etching technique, thereby producing a first patterned block copolymer;

(e) further coating the first patterned block copolymer with a second block copolymer;

(f) annealing the second block copolymer;

(g) etching the second block copolymer by a second etching technique, thereby producing a second patterned block copolymer;

(h) optionally repeating cycles comprising steps (e), (f), and (g); and

(i) passivating the coating;

thereby forming a multi-scale block copolymer coating.

In another aspect, the disclosure relates to an article comprising a surface and a polymer coating on said surface; wherein the polymer coating is poly(styrene-block-dimethylsiloxane).

In still another aspect, the disclosure relates to an article comprising a surface and a polymer coating on said surface; wherein the polymer coating is a block copolymer comprising a plurality of styrene monomers and a plurality of dimethylsiloxane monomers.

In yet another aspect, the disclosure relates to a method of repelling water from a surface of an article, comprising exposing to water a surface of an article disclosed herein.

### BRIEF DESCRIPTION OF THE DRAWINGS

FIG. 1 shows a schematic of the nano-mesh fabrication process. Block copolymer thin films are successively spin-coated, annealed, and etched onto a substrate, and the process is repeated to form a multi-layer stack.

FIG. 2 shows that a water drop displayed a significantly higher contact angle on the substrate imparted with two layer topography compared to control (left panel). Atomic force microscopy reveals the presence of interleaved cylinders with excellent periodicity (right panel).

FIG. 3 shows a multi-scale pattern with three block copolymers using AFM.

FIG. 4 shows a water contact angle measurement on a super-hydrophobic surface comprising a multi-scale block copolymer coating.

FIG. 5 shows water contact angle measurements on a flat substrate treated with perfluorosilane for different durations.

FIG. 6 shows water contact angle measurements on surfaces of different underlying topographies with optimal perfluorosilane treatment.

FIG. 7 shows wetting behavior for a self-cleaning surface comprising a multi-scale block copolymer coating (left) compared to an uncoated surface (right).

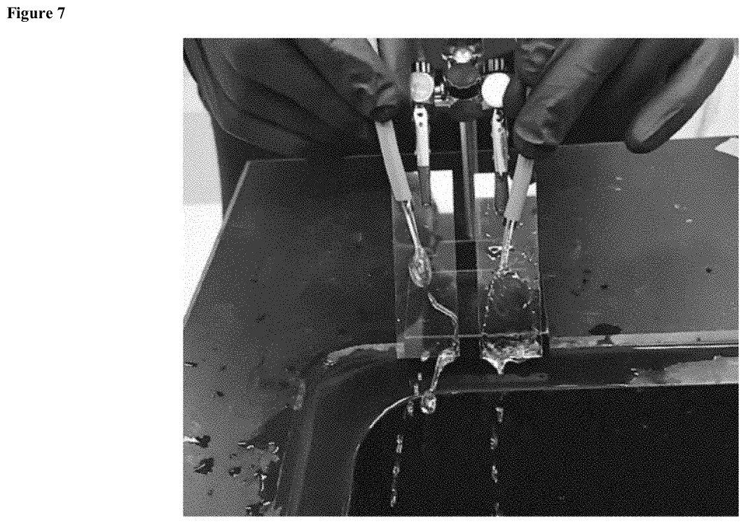

### DETAILED DESCRIPTION

Super-hydrophobic surfaces are defined by their characteristic ability to repel water and resulting resistance to wetting. Quantitatively, super-hydrophobicity corresponds to a water contact angle that exceeds 150° and a roll-off angle less than 10°. Super-hydrophobicity is alternatively called the lotus effect because it underlies the self-cleaning effect of the lotus plant and certain insect wings. One biological solution is to impart the surface with hydrophobicity by introducing topographical features that trap air. The physics governing water-surface interactions is strongly affected by surface roughness and relative surface energies of the system constituents.

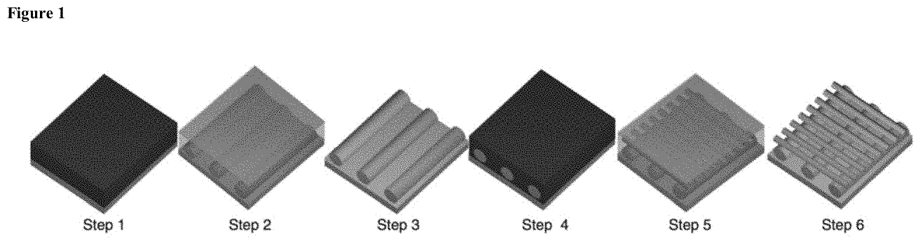

The central premise of the self-cleaning surface rests on the fact that super-hydrophobicity arises from the physical structuring of a surface at the micro- or nano-scale rather than chemical properties of the constituent materials. The target surfaces are imparted with hydrophobicity through deposition of a multi-layer nano-scale pattern of silicon dioxide. FIG. 1 outlines the manufacturing process utilized for assembling the nano-mesh. The process leveraged recent insights from numerical simulations and experiments on orthogonal self-assembly of block copolymers where multiple layers of distinct-molecular-weight block copolymers naturally produce three-dimensional ordered structures of cylindrical micro-domains without requiring layer-by-layer alignment or high-resolution lithographic templating. The principal steps required for experimental realization of this effect are spin-coating, annealing, and etching. Block copolymer thin films are successively spin-coated, annealed, and etched onto a surface to yield durable and optically benign patterns with long-range order. The pattern can then be functionalized with a capping layer of perfluorosilane.

The parameters that modulate the self-assembled pattern include polymer molecular weight, annealing conditions, film thickness per layer, and the total number of layers. The resulting periodic pattern introduces the necessary roughness on the nanoscale to trap air and increase hydrophobicity of the surface, and can be controlled by altering the aforementioned tuning parameters. It is important to note that when the self-assembled block copolymer film is subjected to oxygen plasma, it reveals the final pattern of the polymer and transforms it into non-toxic and highly durable glass. This comes with the added advantage that the optical properties of the underlying material onto which the film is deposited remain unaltered.

### Methods of Coating a Surface

In one aspect, the present disclosure provides a method of coating a surface of a substrate, comprising the steps of:

(a) providing a substrate;

(b) coating the substrate with a first block copolymer;

(c) annealing the first block copolymer on the surface;

(d) etching the first block copolymer by a first etching technique, thereby producing a first patterned block copolymer;

(e) further coating the first patterned block copolymer with a second block copolymer;

(f) annealing the second block copolymer;

(g) etching the second block copolymer by a second etching technique, thereby producing a second patterned block copolymer;

(h) optionally repeating cycles comprising steps (e), (f), and (g); and

(i) passivating the coating;

thereby forming a multi-scale block copolymer coating.

In some embodiments, the block copolymer comprises dimethylsiloxane.

In another aspect, the present disclosure provides a method of coating a surface of a substrate, comprising the steps of:

(a) providing a substrate;

(b) coating the substrate with a first block copolymer;

(c) annealing the first block copolymer on the surface;

(d) exposing the first block copolymer to a first ultraviolet (UV) treatment, thereby producing a first patterned block copolymer;

(e) further coating the first patterned block copolymer with a second block copolymer;

(f) annealing the second block copolymer;

(g) exposing the second block copolymer to a second UV treatment, thereby producing a second patterned block copolymer;

(h) optionally repeating cycles comprising steps (e), (f), and (g); and

(i) passivating the coating;

thereby forming a multi-scale block copolymer coating.

In some embodiments, the block copolymer is carbon-based. In some embodiments, the block copolymer is carbon-based and the pattern of the block copolymer is produced by UV exposure.

In some embodiments of the methods disclosed herein, the substrate is homogeneous.

In some embodiments of the methods disclosed herein, the substrate is planar or non-planar.

In some embodiments of the methods disclosed herein, the substrate is selected from the group consisting of silicon, glass, plastic, quartz, woven or non-woven fabric, paper, ceramic, nylon, carbon, polyester, polyurethane, polyanhydride, polyorthoester, polyacrylonitrile, polyphenazine, polyisoprene, synthetic rubber, polytetrafluoroethylene, polyethylene terephthalate, acrylate polymer, chlorinated rubber, fluoropolymer, polyamide resin, vinyl resin, expanded polytetrafluoroethylene, low density polyethylene, high density polyethylene, and polypropylene. In some embodiments, the substrate is coated with a layer of SiO₂ before coating with a block copolymer. In some embodiments, the substrate is a polymer and is coated with a layer of SiO₂ before coating with a block copolymer. In some embodiments, the substrate is silicon or glass. In some embodiments, the substrate is glass.

In some embodiments of the methods disclosed herein, the surface of the substrate is concave or convex. In some embodiments, the surface of the substrate is flat.

In some embodiments of the methods disclosed herein, the annealing of step (c) or step (f) is solvent annealing.

In some embodiments of the methods disclosed herein, the annealing of step (c) or step (f) is thermal annealing.

In some embodiments of the methods disclosed herein, the etching of step (d) or step (g) is a reactive ion etching. In some embodiments, the reactive ion etching uses a gas mixture comprising fluorine or a gas mixture comprising oxygen. In some embodiments, the gas mixture comprising fluorine is CF₄. In some embodiments, the gas mixture comprising oxygen is O₂. In some embodiments, the reactive ion etching comprises two or more treatments using a gas mixture comprising fluorine or a gas mixture comprising oxygen.

In some embodiments of the methods disclosed herein, the etching of step (d) or step (g) is a plasma etching. In some embodiments, the plasma etching uses a gas mixture comprising oxygen or a gas mixture comprising hydrogen. In some embodiments, the plasma etching uses a gas mixture comprising oxygen. In some embodiments, the plasma etching is oxygen plasma etching. In some embodiments, the reactive ion etching comprises two or more treatments using a gas mixture comprising oxygen or a gas mixture comprising hydrogen.

In some embodiments of the methods disclosed herein, the passivating is with any chemical that provides low surface energy and can be deposited through non-disruptive processes like molecular vapor deposition or dip-coating. In some embodiments, the passivating of step (i) is with a polymer brush or a silane. In some embodiments, the polymer brush forms a monolayer. In some embodiments, the polymer brush is a PDMS brush. In some embodiments, the silane is a fluorosilane. In some embodiments, the silane is a perfluorosilane (e.g., trichloro-(1H,1H,2H,2H-heptadecafluorodecyl)silane. In some embodiments, the silane is (3-amino-propyl)triethoxysilane (APTES).

### Applications and Articles of the Disclosure

Existing products attempt to mimic the lotus leaf surface by introducing micro-scale features onto a target surface in order to generate the necessary roughness for trapping air. Most of these approaches do not result in durable coatings; for instance, fabrics have been imparted with hydrophobicity by coating them with silica particles using the sol-gel technique, but generally do not survive multiple wash cycles or standard daily usage. Nanoscale patterns are an attractive alternative, but generally require expensive fabrication routines that increase production cost and manufacturing latency. Popular products like Ultra-Ever Dry and NeverWet are examples of spray-on products that suffer from durability problems and compromise optical properties of the underlying substrate. Likewise, Pilkington Activ is an example of a nano-patterned self-cleaning glass that requires the use of expensive chemical vapor deposition steps to deposit a thin-film of titanium dioxide. The methods disclosed herein are low-cost and scalable methods of functionalizing surfaces with a durable and optically passive hydrophobic coating in order to impart them with self-cleaning properties. The technology can be used in critical energy applications like solar panels, as well as enhancement of consumer products like eyeglasses, smartphone displays, and vehicular windshields.

In another aspect, the disclosure relates to an article comprising a surface and a polymer coating on said surface; wherein the polymer coating is poly(styrene-block-dimethylsiloxane).

In still another aspect, the disclosure relates to an article comprising a surface and a polymer coating on said surface; wherein the polymer coating is a block copolymer comprising a plurality of styrene monomers and a plurality of dimethylsiloxane monomers.

In some embodiments, the disclosure relates to any one of the aforementioned articles, wherein the article is, or is incorporated into, a fiber or a fabric. In some embodiments, the fiber or fabric is water repellant.

In some embodiments, the water repellant fiber is used in a suit protective against chemical and biological weapons.

In some embodiments, articles of the disclosure are used in optically sensitive settings. For example, the articles of the disclosure can be used in photovoltaics, tactile surfaces, optical lenses, and vehicular windshields. In some embodiments, the articles of the disclosure can be incorporated into solar panels, eyeglasses, smartphone displays, vehicular windshields, windows, microfluidics, and clothing.

In another aspect, provided herein is a method of repelling water comprising exposing the water to any one of the aforementioned articles. In some embodiments, water droplets spontaneously roll-off the article and dislodge dirt.

### Block Copolymers of the Disclosed Methods or Articles

In some embodiments of the methods or articles disclosed herein, a block copolymer self-assembles to minimize free energy. In some embodiments, the block copolymer is a strongly segregating block copolymer. In some embodiments, the block copolymer is a high x block copolymer. In another embodiment, the block copolymer has a large Flory-Huggins interaction parameter, which is related to the energy of mixing. In some embodiments, the block copolymer is a lamellae-forming block copolymer. In some embodiments, the block copolymer is a cylinder-forming block copolymer. In some embodiments, the block copolymer is a sphere-forming block copolymer. In some embodiments, the block copolymer self-assembly is strongly affected by the topography present on the surface.

The block copolymer can include any number of distinct block polymers (i.e., diblock copolymers, triblock copolymers, etc.). In some embodiments, the block copolymer comprises dimethylsiloxane. A specific example is the diblock copolymer poly(styrene-block-dimethylsiloxane) (PS-b-PDMS). Any type of copolymer that undergoes microphase separation under appropriate thermodynamic conditions may be used. This includes block copolymers that have as components glassy polymers, such as PS, which have relatively high glass transition temperatures, as well as more elastomeric polymers.

The block copolymer material may include one or more additional block copolymers. In some embodiments, the material may be a block copolymer/block copolymer blend. An example of a block copolymer/block copolymer blend is PS-b-PDMS (50 kg/mol)/PS-b-PDMS (100 kg/mol).

The block copolymer material may also include one or more homopolymers. In some embodiments, the material may be a block copolymer/homopolymer blend or a block copolymer/homopolymer/homopolymer blend, such as a PS-b-PDMS/PS/PDMS blend.

The block copolymer material may comprise any swellable material. Examples of swellable materials include volatile and non-volatile solvents, plasticizers and supercritical fluids. In some embodiments, the block copolymer material contains nanoparticles dispersed throughout the material. The nanoparticles may be selectively removed.

In some embodiments of the methods or articles disclosed herein, the block copolymer is formed by the copolymerization of styrene with dimethylsiloxane, and optionally with methyl methacrylate, glycidal methacrylate, hydroxyl ethyl methacrylate, acrylates with perfluoro side chains (e.g., 1H,1H,6H,6H-perfluorohexyldiacrylate and 1H,1H,2H,2H-perfluorooctyl acrylate), lactic acid, 2-vinyl pyridine, or 4-vinyl pyridine. In some embodiments, the block copolymer is poly(styrene-block-dimethylsiloxane) (PS-b-PDMS).

In some embodiments of the methods or articles disclosed herein, the block copolymer is carbon-based. For example, the block copolymer is formed by the copolymerization of styrene with methyl methacrylate, glycidal methacrylate, hydroxyl ethyl methacrylate, acrylates with perfluoro side chains (e.g., 1H,1H,6H,6H-perfluorohexyldiacrylate and 1H,1H,2H,2H-perfluorooctyl acrylate), lactic acid, 2-vinyl pyridine, or 4-vinyl pyridine. In some embodiments, the block copolymer is poly(styrene-block-ethylene oxide) (PS-b-PEO), poly(styrene-block-lactic acid) (PS-b-PLA), poly(styrene-block-methacrylate) (PS-b-PMMA), polyhedral oligomeric silsequioxane (POSS)-containing polymers, polystyrene-block-poly(2-vinylpyridine) (PS-b-P2VP), or poly(2-vinylpyridine)-block-polystyrene-block-poly(2-vinylpyridine) (P2VP-b-PS-b-P2VP). In some embodiments, the block copolymer is PS-b-PMMA, P2VP-b-PS-b-P2VP, PS-b-PEO, or PS-PDMS.

In some embodiments of the methods or articles disclosed herein, the first block copolymer has a higher average molecular weight than the second block copolymer.

In some embodiments, the first block copolymer has an average molecular weight of about 100 kg/mol to about 150 kg/mol. In some embodiments, the first block copolymer has an average molecular weight of about 120 kg/mol to about 130 kg/mol. In some embodiments, the first block copolymer has an average molecular weight of about 123 kg/mol. In some embodiments, the first block copolymer has an average molecular weight of about 100 kg/mol, about 105 kg/mol, about 110 kg/mol, about 115 kg/mol, about 120 kg/mol, about 125 kg/mol, about 130 kg/mol, about 135 kg/mol, about 140 kg/mol, about 145 kg/mol, or about 150 kg/mol. In some embodiments, the first block copolymer has an average molecular weight of about 125 kg/mol.

In some embodiments, the second block copolymer has an average molecular weight of about 35 kg/mol to about 65 kg/mol. In some embodiments, the second block copolymer has an average molecular weight of about 50 kg/mol to about 60 kg/mol. In some embodiments, the second block copolymer has an average molecular weight of about 53 kg/mol. In some embodiments, the second block copolymer has an average molecular weight of about 35 kg/mol, about 40 kg/mol, about 45 kg/mol, about 50 kg/mol, about 55 kg/mol, about 60 kg/mol, or about 65 kg/mol. In some embodiments, the second block copolymer has an average molecular weight of about 55 kg/mol.

In some embodiments of the methods or articles disclosed herein, the coating further comprises a third block copolymer.

In some embodiments, the second block copolymer has a higher average molecular weight than the third block copolymer.

In some embodiments, the third block copolymer has an average molecular weight of about 5 kg/mol to about 25 kg/mol. In some embodiments, the third block copolymer has an average molecular weight of about 15 kg/mol to about 20 kg/mol. In some embodiments, the third block copolymer has an average molecular weight of about 16 kg/mol. In some embodiments, the third block copolymer has an average molecular weight of about 5 kg/mol, about 10 kg/mol, about 15 kg/mol, about 20 kg/mol, or about 25 kg/mol. In some embodiments, the third block copolymer has an average molecular weight of about 15 kg/mol.

In some embodiments, the block copolymer with the lowest average molecular weight fits within the pattern of the block copolymer with the highest average molecular weight.

In some embodiments of the methods or articles disclosed herein, the coating further comprises a fourth block copolymer.

In some embodiments of the methods or articles disclosed herein, the coating further comprises a fifth block copolymer.

In some embodiments of the methods or articles disclosed herein, the polymer coating further comprises one or more additional passivation treatments. In some embodiments, the passivation treatment is with any chemical that provides low surface energy and can be deposited through non-disruptive processes like molecular vapor deposition or dip-coating. In some embodiments, the passivation treatment is with a polymer brush or a silane. In some embodiments, the polymer brush forms a monolayer. In some embodiments, the polymer brush is a PDMS brush. In some embodiments, the silane is a fluorosilane. In some embodiments, the silane is a perfluorosilane (e.g., trichloro-(1H,1H,2H,2H-heptadecafluorodecyl)silane. In some embodiments, the silane is (3-Amino-propyl)triethoxysilane (APTES). In some embodiments, the passivation treatment is with APTES followed by perfluorosilane.

### Properties or Characteristics of the Disclosed Methods or Articles

In some embodiments, the disclosure relates to a coating comprising any one of the aforementioned block copolymers, wherein the thickness of the coating material is from about 10 nm to about 1500 nm. In certain embodiments, the invention relates to any one of the aforementioned compositions, wherein the thickness of the coating material is about 10 nm, about 20 nm, about 30 nm, about 40 nm, about 50 nm, about 60 nm, about 70 nm, about 80 nm, about 90 nm, about 100 nm, about 125 nm, about 150 nm, about 175 nm, about 200 nm, about 225 nm, about 250 nm, about 275 nm, about 300 nm, about 325 nm, about 350 nm, about 375 nm, about 400 nm, about 425 nm, about 450 nm, about 475 nm, about 500 nm, about 525 nm, about 550 nm, about 575 nm, about 600 nm, about 625 nm, about 650 nm, about 675 nm, about 700 nm, about 725 nm, about 750 nm, about 775 nm, about 800 nm, about, 825 nm, about 850 nm, about 875 nm, about 900 nm, about 1000 nm, about 1100 nm, about 1200 nm, about 1300 nm, about 1400 nm, or about 1500 nm. In some embodiments, the thickness of the coating material is from about 10 nm to about 300 nm. In some embodiments, the disclosure relates to a coating comprising any one of the aforementioned block copolymers, wherein the coating is durable.

In some embodiments, the disclosure relates to any one of the aforementioned methods or articles, wherein the coating has a RMS roughness of greater than about 40 nm. In some embodiments, the composition has a RMS roughness of about 40 nm, about 45 nm, about 50 nm, about 55 nm, about 60 nm, about 65 nm, or about 70 nm.

In some embodiments, the disclosure relates to any one of the aforementioned methods or articles, wherein the coating is hydrophobic. In some embodiments, the coating is super-hydrophobic.

In some embodiments, the disclosure relates to any one of the aforementioned methods or articles, wherein the coating is self-cleaning. In some embodiments, water droplets spontaneously roll-off the coating and dislodge dirt.

In some embodiments, the disclosure relates to any one of the aforementioned methods or articles, wherein the coating is optically benign. In some embodiments, the coating comprises a pattern with long-range order. In some embodiments, the coating comprises a periodic nanoscale pattern. In some embodiments, the coating comprises a consistent pattern. In some embodiments, the disclosure relates to any one of the aforementioned methods or articles, wherein the pattern is controlled by molecular weight of the polymer, annealing conditions, film thickness per layer, and the total number of layers.

In some embodiments, the disclosure relates to any one of the aforementioned methods or articles, wherein the feature dimensions and periodicity control the multi-layer stacking behavior. In some embodiments, the stacking of block copolymer films creates a multi-scale coating.

In some embodiments, the methods or articles disclosed herein do not rely on lithography or chemical vapor deposition.

In some embodiments, the disclosure relates to any one of the aforementioned methods or articles, wherein the advancing water contact angle is greater than about 90°. In some embodiments, the advancing water contact angle is about 90°, about 95°, about 100°, about 105°, about 110°, about 115°, about 120°, about 125°, about 130°, about 135°, about 140°, about 145°, about 150°, about 155°, about 160°, about 165°, or about 170°. In some embodiments, the advancing water contact angle is greater than about 150°.

In some embodiments, the disclosure relates to any one of the aforementioned methods or articles, wherein the receding water contact angle is greater than about 90°. In certain embodiments, the invention relates to any one of the aforementioned compositions, wherein the receding water contact angle is about 90°, about 95°, about 100°, about 105°, about 110°, about 115°, about 120°, about 125°, about 130°, about 135°, about 140°, about 145°, about 150°, about 155°, about 160°, about 165°, or about 170°. In some embodiments, the receding water contact angle is greater than about 150°.

In some embodiments, the disclosure relates to any one of the aforementioned methods or articles, wherein water rolls off the surface easily.

In some embodiments, the disclosure relates to any one of the aforementioned methods or articles, wherein the WCA hysteresis is less than about 10°. In some embodiments, the WCA hysteresis is about 10°, about 9°, about 8°, about 7°, about 6°, about 5°, about 4°, or about 3°.

In some embodiments, the disclosure relates to any one of the aforementioned methods or articles, wherein the roll-off angle is less than about 10°. In some embodiments, the roll-off angle is about 10°, about 9°, about 8°, about 7°, about 6°, about 5°, about 4°, about 3°, or about 2°.

### Definitions

Unless otherwise defined herein, scientific and technical terms used in this application shall have the meanings that are commonly understood by those of ordinary skill in the art. Generally, nomenclature used in connection with, and techniques of, chemistry described herein, are those well-known and commonly used in the art.

For convenience, certain terms employed in the specification, examples, and are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

“BCP” as used herein is an abbreviation for block copolymer.

### Examples

The invention now being generally described, it will be more readily understood by reference to the following examples, which are included merely for purposes of illustration of certain aspects and embodiments of the present invention, and are not intended to limit the invention.

### Example 1: General Procedures

The film thicknesses were measured by ex-situ variable angle spectroscopy ellipsometry (VASE, JA Woollam M-2000). The measurements were done at three different angles (65°, 70° and 75°) in the wavelength range of 200-1000 nm. The applied optical model consisted of three components: the silicon substrate, the native SiO₂ layer of 1.7 nm and the film bulk layer. The bulk components were modelled by the Cauchy function adding the Urbach tail to model the absorption.

Contact angles (CA) were measured on samples of material cut to about 1 centimeter wide by 1 centimeter long. The samples were placed on a flat metal platform with horizontal and vertical adjustment features. Drops of distilled water (distilled to 18.2 MΩcm using a Milli-Q Water Purification System available from Millipore of Billerica, Mass.) were manually delivered from a 100 microliter syringe to the surface of the sample. Side images of the drops of water on the sample surface were obtained with a camera (Leica Z6 APO A optical zoom system from Leica Microsystems) that was interfaced to a computer via a SONY camera control unit. Auxiliary lighting probes were used to improve the image of the drop. The contact angle at the water/surface interface may be measured from the photo using a standard method, e.g., with an image processing tool.

Surface film morphology was investigated by Atomic Force Microscopy (AFM—Cypher from Asylum Research, Santa Barbara, Calif.). Images were acquired in tapping mode using an uncoated standard silicon tip (Olympus AC160 TS). RMS roughness was measured on 5×5 μm² surface areas. Images were obtained by Scanning Electron Microscopy (SEM, Hitachi, TM 3000) with an acceleration voltage of 15 kV.

### Example 2: Forming a Two-Layer Coating on a Substrate

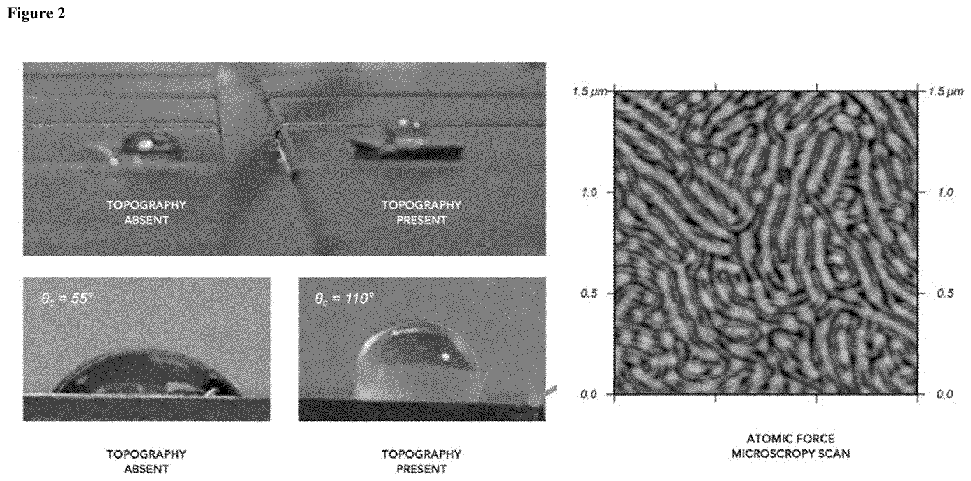

A number of two-layer samples were fabricated, and their hydrophobicity was examined. In FIG. 2, a sample was synthesized using a 123 kg mol⁻¹ poly(styrene-block-dimethylsiloxane) (PS-b-PDMS) as the base layer and 53 kg mol⁻¹ PS-b-PDMS as the stacked layer on a Si wafer. Each layer was solvent annealed for 12 hours in 5:1 Toluene-Heptane and subject to 5 second CF₄ and 30 second O₂ reactive-ion etching cycles before being passivated with a PDMS brush layer. This resulted in a multi-scale pattern of interleaved cylinder as shown in the atomic force microscopy scan in FIG. 2. Compared to a control sample of silicon passivated with a PDMS brush, which showed a water contact angle of 55°, the sample with interleaved cylinder topography showed a contact angle of approximately 110°, indicating the presence of hydrophobicity.

### Example 3: Forming a Three-Layer Coating on a Substrate

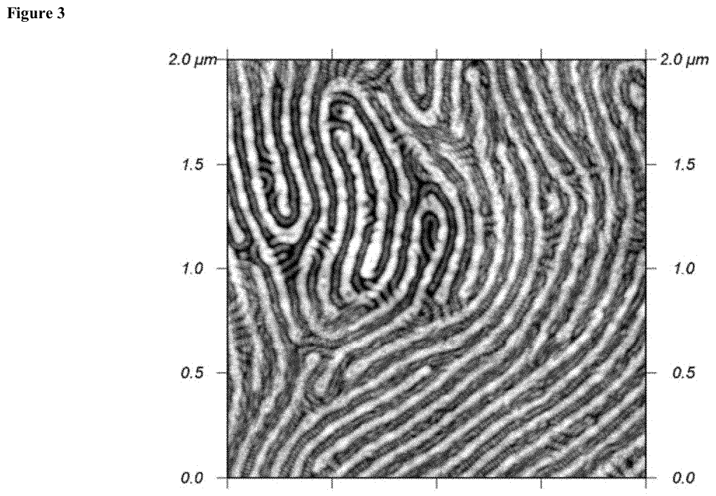

A sample was synthesized using 123 kg mol⁻¹ PS-b-PDMS as the base layer and 53 kg mol⁻¹ PS-b-PDMS and 16 kg mol⁻¹ PS-b-PDMS as the stacked layers on a glass surface. Each layer was solvent annealed for 12 hours in 5:1 Toluene-Heptane and subject to 5 second CF₄ and 30 second O₂ reactive-ion etching cycles before being passivated with Trichloro(1H,1H,2H,2H-heptadecafluorodecyl)silane (a perfluorosilane). This resulted in a multi-scale pattern of interleaved cylinder as shown in the atomic force microscopy (AFM) scan in FIG. 3. The stacking of block copolymer films created a multi-scale intricate pattern. Three different length scales were observed in the AFM scans. The domain sizes scaled with the molecular weight of the polymer. The intermediate cylindrical pattern (SD53 kg mol⁻¹) fit well between the large domains of the base pattern of SD123 kg mol⁻¹. The smallest polymer SD16 kg mol⁻¹ was able to fit both length scales by fitting normal to both underlying structures.

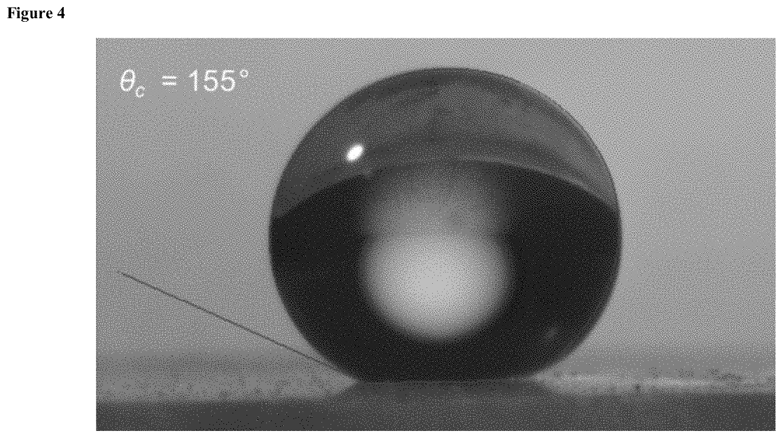

The combination of nanoscale topography and the proper chemical treatment of the surface boosted the glass surface contact angle to 155° (FIG. 4), well within the super-hydrophobic regime. The droplet maintained nearly a spherical shape to minimize contact with the surface. Due to the multi-scale nature of the topography, the adhesion of water to the substrate was significantly reduced compared to a control sample that was subject to chemical treatment in the absence of underlying topography. The pattern had essentially no effect on the surface transparency, leaving the optical properties of glass intact.

### Example 4: Adding Perfluorosilane Treatment

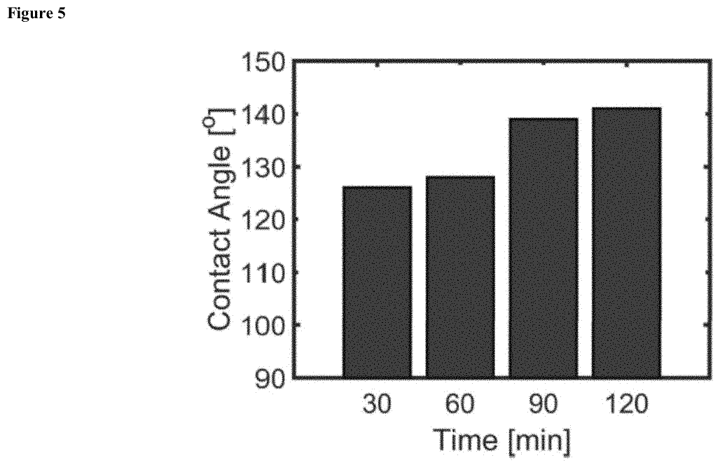

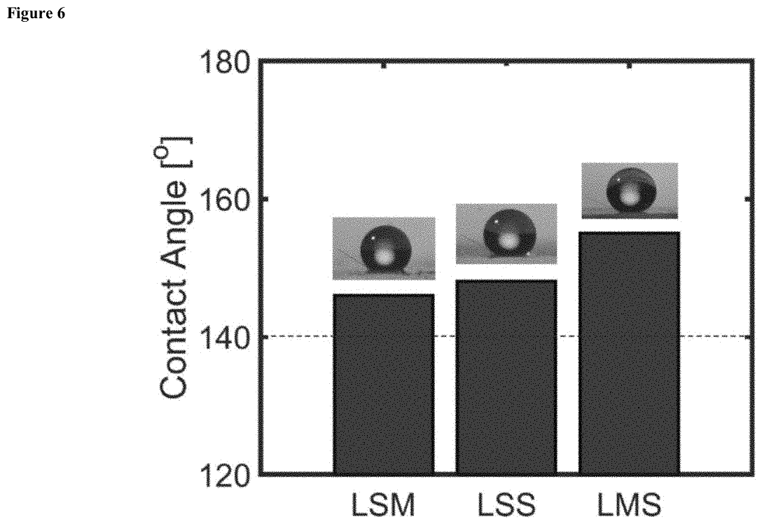

The optimal perfluorosilane treatment was determined for flat glass substrates, and it was determined that an optimal contact angle of 140° was reached after a treatment time of 120 minutes (FIG. 5). This treatment was coupled with a block copolymer multi-stack (similar to the process outlined in Example 3), and the combination provided contact angle improvements of up to 15° (FIG. 6).

### INCORPORATION BY REFERENCE

All US and PCT patent application publications and US patents cited herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

1. A method of coating a surface of a substrate, comprising the steps of:
(a) providing a substrate;
(b) coating the substrate with a first block copolymer;
(c) annealing the first block copolymer on the surface;
(d) etching the first block copolymer by a first etching technique, thereby producing a first patterned block copolymer;
(e) further coating the first patterned block copolymer with a second block copolymer;
(f) annealing the second block copolymer;
(g) etching the second block copolymer by a second etching technique, thereby producing a second patterned block copolymer;
(h) optionally repeating cycles comprising steps (e), (f), and (g); and
(i) passivating the coating;
thereby forming a multi-scale block copolymer coating.

2. The method of claim 1, wherein the substrate is homogeneous.

3. The method of claim 1 or 2, wherein the substrate is planar or non-planar.

4. The method of any one of claims 1-3, wherein the substrate is selected from the group consisting of silicon, glass, plastic, quartz, woven or non-woven fabric, paper, ceramic, nylon, carbon, polyester, polyurethane, polyanhydride, polyorthoester, polyacrylonitrile, polyphenazine, polyisoprene, synthetic rubber, polytetrafluoroethylene, polyethylene terephthalate, acrylate polymer, chlorinated rubber, fluoropolymer, polyamide resin, vinyl resin, expanded polytetrafluoroethylene, low density polyethylene, high density polyethylene, and polypropylene.

5. The method of claim 4, wherein the substrate is further coated with a layer of SiO₂.

6. The method of any one of claims 1-4, wherein the substrate is silicon or glass.

7. The method of any one of claims 1-4, wherein the substrate is glass.

8. The method of any one of claims 1-7, wherein the substrate is optically transparent.

9. The method of any one of claims 1-8, wherein the first or second block copolymer is optically transparent.

10. The method of any one of claims 1-9, wherein the first or second block copolymer is a strongly segregating block copolymer.

11. The method of any one of claims 1-10, wherein the first or second block copolymer is a lamellae-forming block copolymer.

12. The method of any one of claims 1-11, wherein the first or second block copolymer is a cylinder-forming block copolymer.

13. The method of any one of claims 1-12, wherein the first or second block copolymer is poly(styrene-block-dimethylsiloxane) (PDMS).

14. The method of any one of claims 1-13, wherein the first and second block copolymer are poly(styrene-block-dimethylsiloxane).

15. The method of any one of claims 1-14, wherein the first block copolymer has a higher average molecular weight than the second block copolymer.

16. The method of any one of claims 1-15, wherein the first block copolymer has an average molecular weight of about 100 kg/mol to about 150 kg/mol.

17. The method of any one of claims 1-16, wherein the second block copolymer has an average molecular weight of about 35 kg/mol to about 65 kg/mol.

18. The method of any one of claims 1-17, wherein the etching is a reactive ion etching.

19. The method of claim 18, wherein the reactive ion etching uses a gas mixture comprising fluorine or a gas mixture comprising oxygen.

20. The method of any one of claims 1-17, wherein the etching is a plasma etching.

21. The method of claim 20, wherein the plasma etching uses a gas mixture comprising oxygen.

22. The method of any one of claims 1-21, further comprising a third block copolymer.

23. The method of any one of claims 1-22, wherein the second block copolymer has a higher average molecular weight than the third block copolymer.

24. The method of any one of claims 1-23, wherein the third block copolymer has an average molecular weight of about 5 kg/mol to about 25 kg/mol.

25. The method of any one of claims 1-24, including step (h).

26. The method of any one of claims 1-25, wherein the passivating of step (i) is with a polymer brush or a silane.

27. The method of claim 26, wherein the polymer brush is a PDMS brush.

28. The method of claim 26, wherein the silane is a perfluorosilane.

29. The method of any one of claims 1-28, wherein the advancing water contact angle of the coating is greater than about 90°.

30. The method of any one of claims 1-29, wherein the receding water contact angle of the coating is greater than about 90°.

31. The method of any one of claims 1-30, wherein the WCA hysteresis of the coating is less than about 10°.

32. The method of any one of claims 1-31, wherein the coating has a RMS roughness of greater than about 40 nm.

33. An article comprising a surface and a polymer coating on said surface; wherein the polymer coating is poly(styrene-block-dimethylsiloxane).

34. An article comprising a surface and a polymer coating on said surface; wherein the polymer coating is a block copolymer comprising a plurality of styrene monomers and a plurality of dimethylsiloxane monomers.

35. The article of claim 33 or 34, wherein the surface is optically transparent.

36. The article of claim 33 or 34, wherein the polymer coating comprises a first block copolymer and a second block copolymer.

37. The article of claim 36, wherein the second block copolymer is and poly(styrene-block-dimethylsiloxane).

38. The article of claim 36, wherein the second block copolymer comprises a plurality of styrene monomers and a plurality of dimethylsiloxane monomers.

39. The article of any one of claims 36-38, wherein the first block copolymer has a higher average molecular weight than the second block copolymer.

40. The article of any one of claims 36-39, wherein the first block copolymer has an average molecular weight of about 100 kg/mol to about 150 kg/mol.

41. The article of any one of claims 36-40, wherein the second block copolymer has an average molecular weight of about 35 kg/mol to about 65 kg/mol.

42. The article of any one of claims 36-41, further comprising a third block copolymer.

43. The article of claim 42, wherein the second block copolymer has a higher average molecular weight than the third block copolymer.

44. The article of claim 42 or 43, wherein the third block copolymer has an average molecular weight of about 5 kg/mol to about 25 kg/mol.

45. The article of any one of claims 33-44, where the polymer coating further comprises a perfluorosilane.

46. The article of any one of claims 33-45, wherein the advancing water contact angle of the coating is greater than about 90°.

47. The article of any one of claims 33-46, wherein the receding water contact angle of the coating is greater than about 90°.

48. The article of any one of claims 33-47, wherein the WCA hysteresis of the coating is less than about 10°.

49. The article of any one of claims 33-48, wherein the coating has a RMS roughness of greater than about 40 nm.

50. A method of repelling water, comprising exposing to water a surface of an article of any one of claims 33-49.
